(19) United States
(12) Patent Application Publication
(10) Pub. No.: US 2011/0101094 A1
(43) Pub. Date: May 5, 2011

(54) Fuel Distribution Management System

(76) Inventor: Brad Call, North Salt Lake, UT (US)

(21) Appl. No.: 12/768,090

(22) Filed: Apr. 27, 2010

Related U.S. Application Data
(63) Continuation of application No. 11/641,609, filed on Dec. 18, 2006, now abandoned.
(60) Provisional application No. 60/751,340, filed on Dec. 16, 2005.

(51) Int. Cl. G06K 5/00; G06F 17/00

(52) U.S. Cl. 235/381; 700/237

(57) ABSTRACT

A fuel delivery system configured to reduce occurrences of fuel theft comprises an at-the-pump information retrieval system for retrieving information from a consumer. An authorization signal generator is operable to generate an authorization signal when one of at least two conditions relevant to the information retrieved from the consumer exists: i) sufficient funds are available for fuel; or ii) sufficient identification information has been provided. A fuel dispensing system is operable to dispense fuel upon generation of the authorization signal.

### PRIORITY CLAIM

This is a continuation of copending U.S. patent application Ser. No. 11/641,609, filed Dec. 18, 2006, which claims priority to U.S. Provisional Patent Application Ser. No. 60/751,340, filed Dec. 16, 2005, each of which is hereby incorporated herein by reference in its entirety.

### FIELD OF THE INVENTION

The present invention relates generally to systems for controllably providing fuel to consumers. More particularly, the present invention relates to systems for reducing the risk of fuel theft while allowing consumers the option of avoiding the requirement of pre-paying for fuel prior to being allowed to dispense the fuel.

### BACKGROUND OF THE INVENTION

Since the advent of “self-service” gasoline stations, theft of fuel has been a legitimate concern of fuel vendors. Fuels such as gasoline, diesel fuel, propane, natural gas, etc., are often provided to consumers via a “gas pump” near which a consumer typically parks his or her vehicle to add fuel to the vehicle's tank. As it is often unknown precisely how much fuel will be dispensed into a typical fuel tank to fill the tank, a consumer may not know in advance how much fuel he or she wishes to purchase. To accommodate this uncertainty, many gas station operators have allowed consumers to first dispense fuel into the vehicle, and then enter a nearby office or store to render payment for the fuel. Unfortunately, many consumers have taken advantage of the fact that they can pump fuel prior to paying for it, and steal the fuel by leaving the premises without paying for it.

In addition to resulting in millions of dollars of losses each year due to theft-related losses, considerable police resources are also consumed in investigating, apprehending and prosecuting fuel thieves. In addition, the resources of service station personnel are often consumed in monitoring fuel theft, negatively impacting their ability to provide quality customer service in other key areas of the service station business. Also, as fuel thieves often attempt to leave the scene of the crime in a considerable hurry, other patrons and bystanders are exposed to danger as a result of fuel thefts. Thus, fuel thefts negatively affect a number of aspects of the service station industry.

Service station operators currently have at least one option available to them to reduce the occurrences of gas theft: that is to require that all consumers dispensing fuel pre-pay for the fuel. This can be done by either requiring that a consumer utilize a credit or debit card, either in the store or “at the pump,” or by requiring that a consumer pre-pay by depositing a sufficient amount of cash with gas station personnel in the store (or at the pump) prior to dispensing the fuel. While such methods have proved somewhat effective at reducing gas theft, they can involve a significant amount of effort on the part of consumers and gas station personnel if the consumer must first enter the store to place a deposit, return to the pump to dispense fuel, and then reenter the store to finalize his or her transactions.

Due to these inconveniences, service station operators have found that fuel consumers are less likely to avail themselves of other goods and services offered by service stations if the consumers are required to pre-pay for fuel. This is due to the fact that if consumers must pre-pay for their fuel at the pumps, they are less likely to enter the service station where they may decide to purchase beverages, food, sundries, etc. Sales of such goods are often a significant portion of a service station's income. Thus, by requiring that consumers pre-pay for fuel, a service station can negatively affect the profitability of its overall business.

While service station operators have struggled with these issues for some time, it has recently been the case that local governments have begun to enact laws that force service stations to require pre-payment for fuel in order to limit the amount of police resources that are consumed due to gas theft “drive-offs.” Thus, many service station owners or operators now have no choice but to require consumers to pre-pay for gasoline, which can significantly and negatively impact the overall business of the service stations.

### SUMMARY OF THE INVENTION

It has thus been recognized that it would be advantageous to develop a system that effectively reduces occurrences of fuel theft while not negatively affecting in-store sales of food, beverages and sundries at service stations.

The present invention provides a fuel delivery system configured to reduce occurrences of fuel theft, including an at-the-pump information retrieval system for retrieving information from a consumer. An authorization signal generator can be operable to generate an authorization signal when one of at least two conditions relevant to the information retrieved from the consumer exists: i) sufficient funds are available for fuel; or ii) sufficient identification information has been provided. A fuel dispensing system can be operable to dispense fuel upon generation of the authorization signal.

In accordance with another aspect of the invention, a method for controllably delivering fuel, including: providing a fuel dispensing system operable to controllably dispense fuel only upon generation of an authorization signal; obtaining information from the consumer with an at-the-pump information retrieval system; evaluating the information obtained from the consumer to determine if one of at least two conditions exist: i) sufficient funds for fuel are determined to be available by the information retrieval system; or ii) sufficient identification information has been received by the information retrieval system; and generating the authorization signal if one of the at least two conditions exist.

In accordance with another aspect of the invention, a method for reducing theft of fuel from a consumer fuel dispensing system is provided, including: obtaining information from a consumer desiring to dispense fuel with an at-the-pump information retrieval system; evaluating the information obtained from the consumer to determine if one of at least two conditions exist: i) sufficient funds for fuel are determined to be available by the information retrieval system; or ii) sufficient identification information has been received by the information retrieval system; generating the authorization signal if one of the at least two conditions exist; and requiring that the consumer interact with an attendant if one of the at least two conditions doesn't exist.

There has thus been outlined, rather broadly, relatively important features of the invention so that the detailed description thereof that follows may be better understood, and so that the present contribution to the art may be better appreciated. Other features of the present invention will become clearer from the following detailed description of the invention, taken with the accompanying drawings, or may be learned by the practice of the invention.

### BRIEF DESCRIPTION OF THE DRAWINGS

FIG. 1 is a schematic representation of a system for controllably dispensing fuel in accordance with an embodiment of the invention; and

FIG. 2 is a flowchart illustrating an exemplary method for controllably dispensing fuel in accordance with an embodiment of the invention.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification, the singular forms “a” and “the” include plural referents, unless the context clearly dictates otherwise. Thus, for example, reference to a “card reader” can include one or more of such card readers.

Distances, angles, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value and should apply regardless of the breadth of the range or the characteristics being described.

It is of particular note that the systems illustrated in the attached figures are shown schematically and, as such, are not intended to be accurate representations of the physical appearance of such systems. The various components of the systems may not be drawn to scale and may not be accurately scaled relative to one another. It is contemplated that those having ordinary skill in the art can readily conceive of numerous varieties of fuel distribution systems that can incorporate, or into which can be incorporated, the novel features of the present invention.

### INVENTION

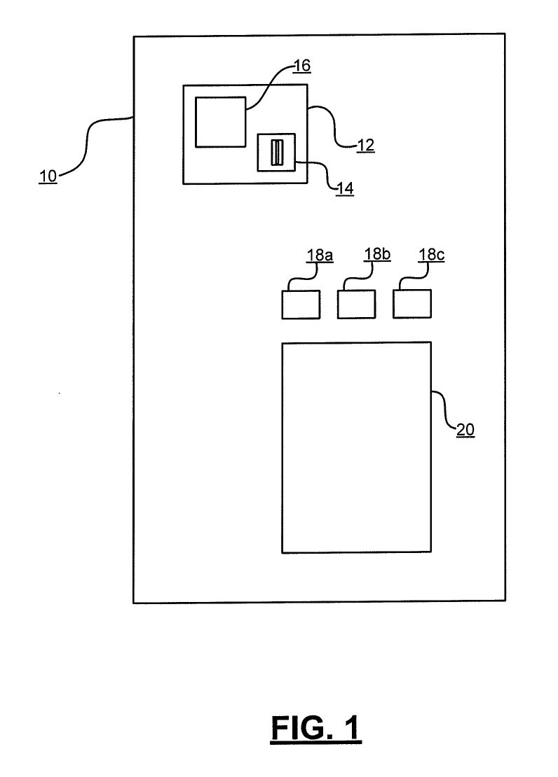

As illustrated generally in FIG. 1, the present invention provides a fuel delivery system 10 configured to reduce occurrences of fuel theft while avoiding pre-payment requirements. While the invention is not so limited, the system shown can appear similar to a conventional “gas pump” system that is generally located some distance from a service center that includes a store that offers for sale beverages, food, sundries, etc. (in addition to providing a location for patrons to render payment for the fuel). The present invention can advantageously provide owners and operators of service stations, or “gas” stations, a manner of reducing the occurrences of gas theft without incurring the negative consequence of reducing in-store traffic. By utilizing the present invention, service station owners and operators can safely allow patrons to dispense fuel without requiring pre-payment from the patrons. After dispensing his or her fuel, the patron can enter the service station and purchase other goods from service station personnel while rendering payment for the fuel dispensed.

In an effort to simplify and clarify the present disclosure, the discussion herein will focus on those aspects of the invention that are incorporated into the types of conventional service stations, gas stations or convenience stores that offer fuel for sale at fuel pumps located adjacent to the service station and also offer for sale beverages, food and sundries within the service station. It is to be understood however, that the present invention can be readily adapted for use with a variety of commercial fuel delivery systems in a variety of settings, and is not limited to the conventional service stations discussed herein. As one example, it is contemplated that the present invention can be readily adapted for use in a setting in which commercial drivers can utilize a community fuel delivery station without requiring payment by the drivers with a credit/debit card.

The system 10 can include an information retrieval system 12 that can be operable to retrieve or receive information from a consumer. The information provided by the consumer can be of a variety of types, including financial information (e.g., credit or debit card information), official record information (e.g., driver's license number, social security number, employee ID information, military identification information, etc.), and/or personal information associated with the individual (e.g., name, address, telephone number, group membership information, etc.). In this manner, the information retrieval system can receive information from a variety of groups of types of information, including in one embodiment, the two distinct types of financial information and personal information.

The information retrieval system 12 can include a card reader 14 that can be operable, for example, to read a magnetically-encoded strip on a card “swiped” through the reader. The card reader can be of a variety of types known to those having ordinary skill in the art, including, for example, commonly known readers that are utilized in credit-card and debit-card systems. Thus, in one embodiment of the invention, the information retrieval system can include a well-known credit-card reader that can collect the information stored on a consumer's credit or debit card. The card reader can also be configured to retrieve financial information stored on IC-cards, “smart cards,” etc.

The card reader 14 can also be configured to collect personal information relating to an individual that can be, but is not necessarily, stored on another media. For example, in one aspect of the invention, a consumer can be prompted to “swipe” a type of card commonly known as a “club card,” to provide the information retrieval system with information that may not be financial in nature. Club cards have enjoyed relatively wide-spread use lately as a means for service stations owners (and other business owners) to both: i) track personal spending habits of consumers; and ii) to reward return customers with either savings on present or future purchases, or with gifts or cash-back programs based on the quantity of goods or services the consumer purchases. In this manner, the service station benefits from repeat business while the consumer benefits from receiving the rewards or price breaks.

In one exemplary embodiment of the present invention, the information retrieval system 12 can include a card reader 14 that is operable to read a variety of types of cards that contain a magnetic strip and that can generally distinguish between differing types of such cards. For example, many magnetic strip cards include “BIN” numbers that allow a card reader to identify which type of card the magnetic strip is applied to. Card readers can thus differentiate between cards such as credit or debit cards and cards used as “club cards.” Accordingly, in one embodiment of the invention, a consumer can swipe his or her credit or debit card and the information retrieval system can automatically transmit the information to the consumer's financial institution to charge the gas purchase to the consumer's account, a process that is well known in the financial arts. In another embodiment, a person can swipe his or her “club card” and the information retrieval system can record the details of a transaction, e.g., the identity of the consumer and/or how much fuel the consumer purchases

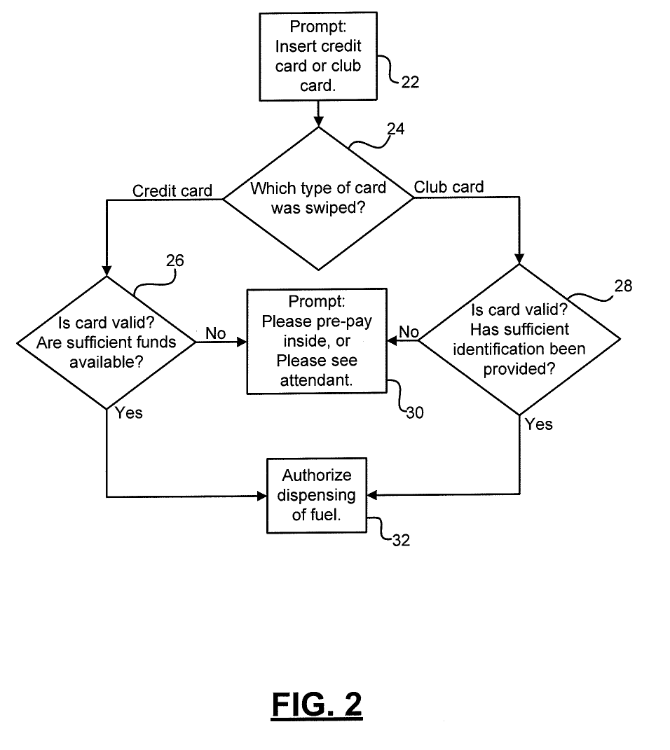

In one embodiment of the invention, the information retrieval system 12 can be used to allow a patron to dispense fuel without pre-paying for the fuel, while at the same time limiting liability on the service-station owner's part that the consumer will attempt to steal the fuel (e.g., not pay for the fuel). This embodiment of the invention is illustrated by example in the flowchart of FIG. 2. As shown at 22, a consumer who wishes to purchase fuel can be prompted by the system to insert a credit card or a club card into the reader 14 (the information retrieval system can include a display/data input component 16 to facilitate communication between the patron and the gas dispensing system 10). At 24, the system can determine which type of card has been swiped. In the event the patron “swipes” a credit or debit card, the process can determine at 26 whether said credit or debit card is valid (e.g., not stolen) and whether use of the card will guarantee the fuel vendor payment for the fuel (e.g., that the card account is not extended beyond available limit or that sufficient funds are held within the card account to cover the transaction).

If the card is valid and sufficient funds are available, the method can proceed to 32 where the information retrieval system 12 can indicate to the fuel dispensing system (shown by example at 20 in FIG. 1) to proceed with dispensing of fuel. At this point in the process, it may be necessary for the consumer to select a grade or type of fuel to be dispensed, via inputs 18a, 18b and 18c, as is well known in the art of fuel delivery, after which the fuel dispensing system will become active. Dispensing of fuel can then proceed in the normal manner.

In the case that the card swiped is not a credit card but rather is a “club card,” the system can check at 28 whether the club card is valid, and whether the information associated with the club card meets a predetermined minimum level of information that the fuel station operator or owner has deemed sufficient to allow the patron to continue with the fuel dispensing process. Thus, assuming the information is sufficient, the process can proceed to 32 where dispensing of the fuel can be authorized.

In the event that the credit card is not valid, or that the credit card is overextended, or that the club card is not valid, the process can terminate at 30 where the patron or consumer is prompted to enter the store to pre-pay or to seek assistance from an attendant.

Thus, as the present system can confirm, due to the fact that the club card is associated with an identifiable individual, who is requesting to dispense fuel without pre-paying, the system can allow owners or operators to confidently authorize patrons to dispense fuel without prepaying, as the patron or consumer will be much less likely to attempt to steal fuel if he or she knows that the owner or operator can track his or her identity.

The information retrieved from the information retrieval system (e.g., the information associated with the club card), can be of a variety of types, including an individual's name, address, telephone number, driver's license number, social security number, etc. Depending on the environment in which the service station is located, the owner or operator, who can be involved in (or responsible for) issuing the club card, can require more or less personal information be associated with each club card relative to factors such as population density adjacent the service station, crime rate in the neighborhood, number of similarly situated service centers in the area, etc. Thus, an owner or operator of a service station can tailor the present invention to his or needs and/or his or her customers.

The present invention can advantageously be used to address the concerns of local governments that may otherwise be interested in mandating that service station owners or operators require pre-payment from consumers in order to minimize police resources used to address fuel thefts. If the local governments are presented with a method of greatly discouraging fuel thefts by tracking, on an individual basis, all consumers who don't pre-pay for fuel, the regulatory bodies may be more likely to allow service stations to address the issue in a manner that is much more cost-effective for the service stations. In the event that a consumer does attempt to steal fuel with the current system, it can be a matter of little difficulty for police to be provided with identification information of the individual, and, in a relatively safe environment, the police can cite or otherwise initiate prosecution of the individual for the theft.

While one exemplary embodiment of the invention is shown in the flowchart of FIG. 2, it is contemplated that the present invention can be executed in a variety of manners. For example, in one embodiment, the process can begin by prompting a potential fuel consumer to swipe his or her club card. In the event that the consumer does not possess such a card, the system can require that the consumer pre-pay before any fuel is dispensed. In the event the consumer does have a club card and swipes it through the reader, the system can send a signal to in-store personnel that a club card member is requesting to dispense fuel without pre-paying (similar to conventional systems that transmit a signal that a consumer is requesting to pump gas and “pay inside”). As the in-store personnel can be relatively sure that the consumer who possesses the club card can be identified later via data received from the club card, the in-store personnel can remotely authorize the fuel dispensing system to dispense fuel without having to record the license plate of the vehicle, or to take other anti-theft measures previously required of in-store personnel.

It is to be understood that the above-described arrangements are only illustrative of the application of the principles of the present invention. Numerous modifications and alternative arrangements may be devised by those skilled in the art without departing from the spirit and scope of the present invention and this description is intended to cover such modifications and arrangements. For example, while a single card reader 12 is shown in FIG. 1, it is to be understood that multiple card readers can be incorporated into the present invention, and that “readers” other than card readers can be used, including optical storage device readers, smart card readers, IC-card readers, etc. Also, while the information retrieval system illustrated in the figures is shown incorporated into a convention “gas pump” configuration, it is to be understood that the various components of the present invention can be oriented or located in a variety of positions relative to one another.

Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

I claim:

1. A fuel delivery system configured to reduce occurrences of fuel theft, comprising:
an at-the-pump information retrieval system for retrieving information from a consumer;
an authorization signal generator, the authorization signal generator being operable to generate an authorization signal when one of at least two conditions relevant to the information retrieved from the consumer exist: i) sufficient funds are available for fuel; or ii) sufficient identification information has been provided; and
a fuel dispensing system, operable to dispense fuel upon generation of the authorization signal.

2. The system of claim 1, further comprising an information reader operable to read information from information-bearing devices.

3. The system of claim 2, wherein the information reader is operable to read information from information-bearing devices selected from the group consisting of:
credit cards, debit cards, smart cards, identification cards, drivers' licenses and club cards.

4. The system of claim 2, wherein the information reader is operable to read information from a vendor-issued club card.

5. The system of claim 4, wherein the vendor-issued club card bears information related to the card holder that is sufficiently detailed to enable law enforcement personnel to identify the holder of the cub card.

6. The system of claim 5, wherein the vendor-issued club card includes no financial information.

7. The system of claim 4, wherein the vendor-issued club card bears information specific to the vendor that issued the card.

8. The system of claim 4, wherein the vendor-issued club card forms part of a rewards system utilized by the vendor.

9. A method for controllably delivering fuel, comprising:
providing a fuel dispensing system operable to controllably dispense fuel only upon generation of an authorization signal;
obtaining information from the consumer with an at-the-pump information retrieval system;
evaluating the information obtained from the consumer to determine if one of at least two conditions exist: i) sufficient funds for fuel are determined to be available by the information retrieval system; or ii) sufficient identification information has been received by the information retrieval system; and
generating the authorization signal if one of the at least two conditions exist.

10. The method of claim 9, further comprising an information reader operable to read information from information-bearing devices.

11. The method of claim 10, wherein the information reader is operable to read information from information-bearing devices selected from the group consisting of:
credit cards, debit cards, smart cards, identification cards, drivers' licenses and club cards.

12. The method of claim 10, wherein the information reader is operable to read information from a vendor-issued club card.

13. The method of claim 12, wherein the vendor-issued club card bears information related to the card holder that is sufficiently detailed to enable law enforcement personnel to identify the holder of the cub card.

14. The method of claim 13, wherein the vendor-issued club card includes no financial information.

15. The method of claim 12, wherein the vendor-issued club card bears information specific to the vendor that issued the card.

16. The method of claim 12, wherein the vendor-issued club card forms part of a rewards system utilized by the vendor.

17. The method of claim 9, further comprising requiring that the consumer interact with an attendant prior to dispensing fuel if one of the at least two conditions doesn't exist.

18. A method for reducing theft of fuel from a consumer fuel dispensing system, comprising:
obtaining information from a consumer desiring to dispense fuel with an at-the-pump information retrieval system;
evaluating the information obtained from the consumer to determine if one of at least two conditions exist: i) sufficient funds for fuel are determined to be available by the information retrieval system; or ii) sufficient identification information has been received by the information retrieval system;
generating the authorization signal if one of the at least two conditions exist; and
requiring that the consumer interact with an attendant if one of the at least two conditions doesn't exist.

19. The method of claim 18, wherein obtaining information and evaluating the information are automated processes.

20. The method of claim 18, wherein obtaining information from the consumer includes reading information from a club card issued to the consumer by the vendor.
